(19) United States
(12) Patent Application Publication
(10) Pub. No.: US 2014/0163845 A1
(43) Pub. Date: Jun. 12, 2014

(54) HYDRAULIC ACCUMULATOR FILL ESTIMATION FOR CONTROLLING AUTOMATIC ENGINE STOP/START

(71) Applicant: GM GLOBAL TECHNOLOGY OPERATIONS LLC, Detroit, MI (US)

(72) Inventors: Paul G. Otanez, Troy, MI (US); Zhen J. Zhang, Canton, MI (US); Casie M. Bockenstette, Clarkston, MI (US); Todd R. Berger, Pinckney, MI (US); Kristopher J. Kokko, Novi, MI (US); Min K. Kim, Troy, MI (US)

(73) Assignee: GM GLOBAL TECHNOLOGY OPERATIONS LLC, Detroit, MI (US)

(21) Appl. No.: 13/712,148

(22) Filed: Dec. 12, 2012

(51) Int. Cl. F02D 29/02

(52) U.S. Cl. CPC F02D 29/02
USPC 701/112

(57) ABSTRACT

A method of preventing an automatic engine stop includes: determining a pressure difference between an accumulator fill volume and a fluid conduit in selective fluid communication with the accumulator fill volume; determining a change in the accumulator fill volume from the determined pressure difference; adding the change in the accumulator fill volume to a previous estimate of the accumulator fill volume to determine a current estimate of the accumulator fill volume; comparing the current estimate of the accumulator fill volume to a predetermined threshold; and preventing an automatic engine stop if the current estimate of the accumulator fill volume is below the predetermined threshold.

### TECHNICAL FIELD

The present invention relates to a method of estimating a fill level for a hydraulic accumulator, and more particularly to a method of controlling an automatic engine stop/start using the estimation.

### BACKGROUND

A typical automatic transmission includes a hydraulic control system that may be used to fluidly engage one or more clutches, brakes, or other torque transmitting devices. The hydraulic control system may include one or more fluid pumps and one or more electronically actuated valves, which may cooperate to selectively provide a pressurized fluid, such as oil, through a fluid circuit to the one or more fluidly actuated torque transmitting devices. The one or more fluid pumps may be selectively driven by either the engine of the motor vehicle, or by an on-board electrical power source to pressurize the hydraulic fluid.

In order to increase the fuel economy of motor vehicles, it may be desirable to stop the engine during certain circumstances, such as when stopped at a red light or idling. However, during this automatic stop, an engine-driven pump may no longer be driven by the engine. Accordingly, hydraulic fluid pressure within the hydraulic control system may drop, which may, in turn, cause the clutches and/or brakes within the transmission to be fully disengaged. As the engine restarts, these clutches and/or brakes may take time to reengage, resulting in slippage and/or delay between engagement of the accelerator pedal or release of the brake and the movement of the motor vehicle.

### SUMMARY

A method of preventing an automatic engine stop includes: determining a pressure difference between an accumulator fill volume and a fluid conduit in selective fluid communication with the accumulator fill volume; determining a change in the accumulator fill volume from the determined pressure difference; adding the change in the accumulator fill volume to a previous estimate of the accumulator fill volume to determine a current estimate of the accumulator fill volume; comparing the current estimate of the accumulator fill volume to a predetermined threshold; and preventing an automatic engine stop if the current estimate of the accumulator fill volume is below the predetermined threshold.

In one configuration, determining a pressure difference between an accumulator fill volume and a fluid conduit in selective fluid communication with the accumulator fill volume may include: estimating an accumulator pressure from an estimate of an accumulator volume and an established relationship between volume and pressure for the accumulator; determining a line pressure for the fluid conduit; and calculating a difference between the estimated accumulator pressure and determined line pressure.

Likewise, determining a change in the accumulator fill volume from the determined pressure difference may include: determining a fill status for the accumulator, the fill status corresponding to the rate and direction of fluid flow into or out of the accumulator; selecting a lookup table corresponding to the determined fill status; and selecting a change in the accumulator fill volume from the selected lookup table using the determined pressure difference.

In another configuration, the method may include monitoring a temperature of a hydraulic fluid, the hydraulic fluid configured to flow within the fluid conduit and accumulator fill volume. The change in the accumulator fill volume may accordingly be selected from the lookup table using the determined pressure difference and the monitored temperature.

The method may additionally include permitting an automatic engine stop if the current estimate of the accumulator fill volume is above the predetermined threshold; monitoring an amount of clutch slip during an automatic engine restart; and applying a correction factor to an accumulator leak rate if the amount of clutch slip exceeds a threshold. The correction factor may be an amount, such that following the application of the correction factor, an established accumulator leak rate may increase by a small amount. As a result, the accumulator volume may decrease at a slightly faster rate during an automated stop or a coast down during which the accumulator pressure is greater than the determined line pressure. The correction factor may be cumulative.

In a similar manner, a vehicle may include an engine in power-flow communication with a transmission, a fluid pump, a hydraulic accumulator, and a controller. The transmission may include at least one fluidly actuated torque transmitting device, and the fluid pump may be in mechanical communication with the engine, and in selective fluid communication with the at least one fluidly actuated torque transmitting device through a fluid conduit. The fluid pump may be configured to supply a pressurized hydraulic fluid through the fluid conduit.

The hydraulic accumulator may be in fluid communication with the fluid conduit, and may define an accumulator fill volume. The hydraulic accumulator may be configured to maintain an amount of pressurized hydraulic fluid within the accumulator fill volume and selectively release it at the direction of the controller.

The controller may be configured to estimate the amount of fluid within the accumulator fill volume by: determining a pressure difference between the accumulator fill volume and the fluid conduit; determining a change in the accumulator fill volume from the determined pressure difference as a function of temperature; and adding the change in the accumulator fill volume to a previous estimate of the accumulator fill volume to determine a current estimate of the accumulator fill volume.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagram of a vehicle including an engine, transmission, and hydraulic control system.

FIG. 2A is a schematic cross-sectional view of a hydraulic accumulator in a discharging state.

FIG. 2B is a schematic cross-sectional view of a hydraulic accumulator in a high-flow charging state.

FIG. 2C is a schematic cross-sectional view of a hydraulic accumulator in a low-flow charging state.

FIG. 3 is a schematic graph illustrating accumulator volume pressure as a function of fluid volume within the accumulator.

FIG. 4 is a schematic flow chart of a method of estimating an accumulator volume, and interrupting vehicle activity if the accumulator volume estimate is below a predetermined threshold.

FIG. 5 is a schematic flow chart of a first method of estimating a required time to fill an accumulator, and interrupting vehicle activity if the time filling the accumulator is below the estimated time.

FIG. 6 is a schematic flow chart of a second method of estimating a required time to fill an accumulator, and interrupting vehicle activity if the time filling the accumulator is below the estimated time.

### DETAILED DESCRIPTION

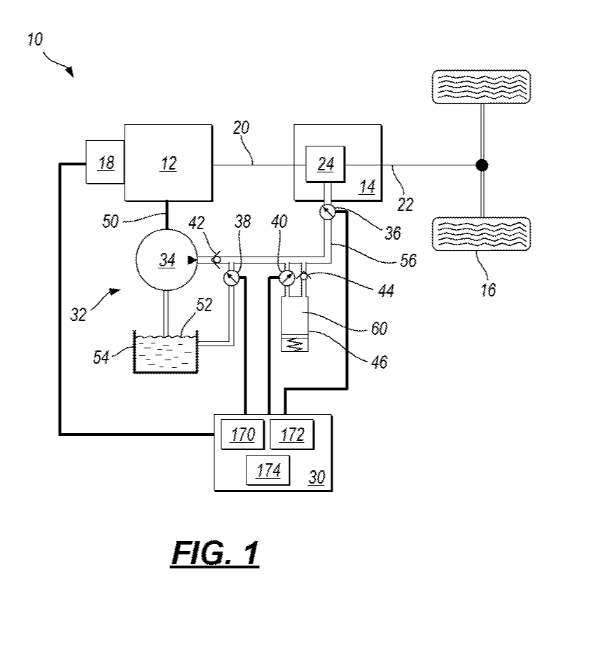

Referring to the drawings, wherein like reference numerals are used to identify like or identical components in the various views, FIG. 1 schematically illustrates a vehicle 10 that may include an internal combustion engine 12 in power-flow communication with a transmission 14, and a plurality of drive wheels 16. The engine 12, transmission 14, and drive wheels 16 may cooperate to provide a motive force to the vehicle 10. The internal combustion engine 12 may be a spark-ignited gasoline engine, a compression-ignited diesel engine, and/or may be configured to operate by combusting one or more other volatile compounds/fuels, such as alcohol, ethanol, methanol, biofuel, or any other fuel known in the art. The engine 12 may include or be coupled with a starting device 18 that may mechanically rotate a crankshaft to begin cycling the engine 12. The starting device 18 may include a hydrodynamic device, such as a fluid coupling or torque converter, a wet dual clutch, and/or an electric motor.

In one configuration, the transmission 14 may be a multi-gear automatic transmission that may selectively transmit a torque from an input shaft 20 of the transmission 14 to an output shaft 22 of the transmission 14. In some configurations, the transmission 14 may include one or more electric motors capable of augmenting the torque produced by the engine 12.

The transmission 14 may include one or more fluidly-actuated, torque-transmitting devices 24, used to selectively couple the input shaft 20 and output shaft 22 at a desired transmission ratio. Such torque-transmitting devices 24 may include one or more clutches or brakes that may selectively engage or disengage when a pressurized fluid is provided to an apply volume associated with the device 24. The transmission 14 may further include a plurality of gear sets, with each set respectively including one or more individual gears and/or planetary gear sets.

The vehicle 10 may further include a control module 30, such as an engine control module (ECM), transmission control module (TCM), and/or a hybrid control module (HCM) that may serve to control the operational behavior of the engine 12, transmission 14, and/or a hydraulic control system 32 associated with the engine 12 and transmission 14. The control module 30 may be embodied as one or multiple digital computers or data processing devices, having one or more microcontrollers or central processing units (CPU), read only memory (ROM), random access memory (RAM), electrically-erasable programmable read only memory (EEPROM), a high-speed clock, analog-to-digital (A/D) circuitry, digital-to-analog (D/A) circuitry, input/output (I/O) circuitry, and/or signal conditioning and buffering electronics. The control module 30 may be configured to automatically perform one or more control/processing routines that may be embodied as software or firmware associated with the module 30.

The hydraulic control system 32 may be operable to selectively engage the one or more fluidly-actuated torque-transmitting devices 24 of the transmission 14, and may include, for example, a fluid pump 34 associated with the engine 12, one or more electronically actuated control valves 36, 38 40, one or more check valves 42, 44, and an accumulator 46.

In one configuration, the fluid pump 34 may be mechanically driven by a rotating member 50 of the engine 12, and may be operable to selectively communicate a hydraulic fluid 52 from a sump 54 to a fluid conduit 56 associated with the hydraulic control system 32. The sump 54 generally serves as a fluid reservoir where excess hydraulic fluid 52 may be stored when not performing work. A first check valve 42 may prevent back flow of the pressurized hydraulic fluid into the pump 34 when the pump 34 is not operational. In other configurations, electrically driven fluid pumps may similarly be used.

A first control valve 36 may selectively control the flow of hydraulic fluid 52 from the hydraulic control system 32 to the fluidly-actuated torque-transmitting device 24 at the direction of the control module 30. Likewise, an optional second control valve 38 may selectively control the flow of hydraulic fluid 52 from the fluidly-actuated torque-transmitting device 24 to the sump 54.

The accumulator 46 operates as an energy storage device that maintains the non-compressible hydraulic fluid 52 under pressure by an external source. In the example provided, the accumulator 46 is a spring type or gas filled type accumulator having a spring or compressible gas that provides a compressive force on the hydraulic fluid 52 within the accumulator 46. It should be appreciated, however, that the accumulator 46 may be of other types, such as a gas-charged type, without departing from the scope of the present invention. Accordingly, the accumulator 46 may be operable to supply pressurized hydraulic fluid 52 back to the main fluid conduit 56 when an immediate charge is required. The first check valve 42 may be configured to constrain the accumulator-supplied charge solely within the fluid circuit and may prevent the pressurized hydraulic fluid 52 from returning to the pump 34. Therefore, a charged (fluid-filled) accumulator 46 may effectively replace or augment the pump 34 as the source of pressurized hydraulic fluid 52, thereby eliminating the need for the pump 34 to run continuously and/or the need for the pump to be oversized to accommodate rapid clutch-fills.

In one configuration, the accumulator 46 may be in fluid communication with the remainder of the hydraulic control system 32 though a third control valve 40 and a second check valve 44, disposed in a parallel arrangement. In other configurations, the second check valve 44 may be omitted.

The accumulator 46 may enable the vehicle 10 to automatically stop once the vehicle 10 is idled/brought to rest, and immediately re-start once an acceleration and/or restart signal is subsequently detected (referred to as an “automatic stop/start”). As may be appreciated automatic stop/starts may provide for an increase in fuel economy, since fuel is not being consumed merely to keep the engine idling. In such an event, the accumulator 46 is used to deliver fluid pressure to the one or more torque-transmitting devices 24 during an auto-start event and until the engine 12 and mechanically driven fluid pump 34 can achieve a speed sufficient to sustain the fluid pressure demands.

In this vein, as soon as the driver lets go of the brake to exit the automatic stop/start, the accumulator 46 is responsible for quickly charging the one or more torque-transmitting devices 24 (as the pump 34 is either “off” or at a low speed). Once the engine 12 and pump 34 are allowed to spool to a minimum operating speed, hydraulic pressure may then be supplied predominantly by the fluid pump 34. If the fluid pressure within the accumulator 46 is insufficient to cause this initial clutch-engagement, however, the control module 30 may be configured to disallow the engine 12 from shutting off at an idle condition. Said another way, only when the accumulator 46 is adequately charged will an automatic stop/start event be allowed. This protection serves to preserve clutch life and provide a smooth re-start to the driver. If the accumulator charge is insufficient to fully pressurize a clutch, that clutch could excessively slip, which may result in an engine flare, a harsh clutch apply, or increased clutch wear (reduced clutch life).

The charge within the accumulator 46 may be expressed in terms of the volume 60 of hydraulic fluid 52 within the accumulator 46 (i.e., “accumulator volume 60” or “accumulator fill volume 60”). As will be described below, in one configuration, accumulator volume 60 may be generally determined by indirectly monitoring and integrating the amount of fluid 52 that enters and leaves the accumulator 46. The fluid flow into/out of the accumulator volume 60 is likewise a function of the difference in pressure between the accumulator volume 60 and the fluid conduit 56. If using the pressure difference to derive flow, certain constraints must also be applied. For example, accumulator pressure is generally bounded between zero fluid pressure and the pump/line pressure; likewise, due to fixed constraints on the movable baffle, accumulator volume 60 is generally bounded between zero volume and the maximum physical volume of the accumulator (ideally greater than or equal to the maximum fill-volume of the torque-transmitting devices 24).

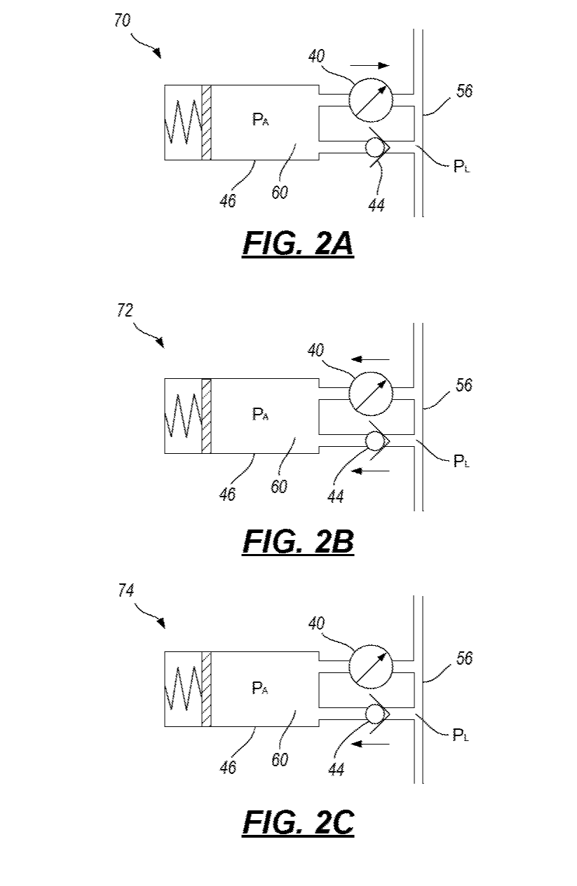

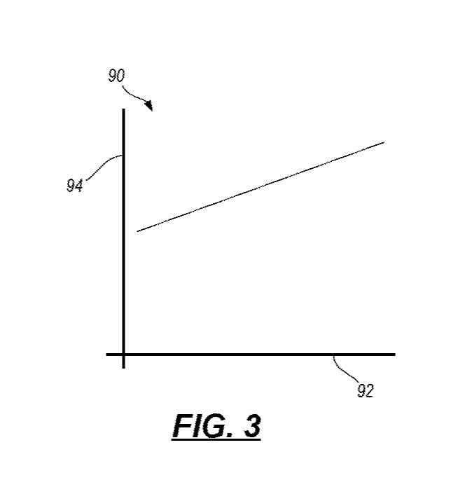

FIGS. 2A, 2B, and 2C illustrate three scenarios where the accumulator is either charging or discharging, as indicated by the arrows leading into or out of the accumulator:

FIG. 2A illustrates a first scenario 70 where the accumulator pressure (P_{A}) is greater than the line pressure (P_{L}), and the control valve 40 is on (open) to allow for rapid discharge (e.g., to accomplish a clutch-fill, such as immediately following the re-start in the automatic stop/start). While the check valve 44 is configured to prevent fluid discharge, the entire fluid outflow may pass through the open control valve 40. The flow rate of the fluid discharge from the accumulator is a function of the temperature of the fluid, and the difference between P_{A} and P_{L}.

FIG. 2B illustrates a second scenario 72 where the accumulator pressure (P_{A}) is less than the line pressure (P_{L}), and the control valve 40 is on (open) to allow for rapid fluid charging. Such a scenario may occur following the discharge shown in FIG. 2A, once the pump is brought up to speed. As shown in FIG. 2B, during the high flow re-charge, fluid may enter through both the check valve 44 and through the control valve 40.

FIG. 2C illustrates a third scenario 74 where the accumulator pressure (P_{A}) is less than the line pressure (P_{L}), and the control valve 40 is off (closed), to allow a lower flow-rate charge as compared with the second scenario 72 of FIG. 2B. As such, the only fluid path into the accumulator 46 is through the check valve 44. Such a lower-charge rate may be desirable if an increased fluid demand is requested by the transmission 14 when it is known that the accumulator is nearly discharged. As such, by restricting flow into the accumulator, the pump may provide an increased flow directly to the transmission 14.

In each scenario, accumulator volume 60 (AV) at time t can be estimated according to the formula below:

AVₜ=AVₜ₋₁+ΔAV

where AVₜ₋₁ is an accumulator volume at a previous time, and ΔAV is a change in volume due to a fluid flow into or out of the accumulator 46. The controller 30 may obtain an estimate for ΔAV from either a lookup table or from analytical equations for fluid flow. In one configuration, the fluid flow may be determined from the charging state of the accumulator (i.e., which of FIGS. 2A, 2B, or 2C is the operative charging state), ΔP (i.e., the difference between P_{A} and P_{L}), and the temperature of the fluid. As noted above, AV can not exceed the maximum physical accumulator volume, nor can it fall below zero.

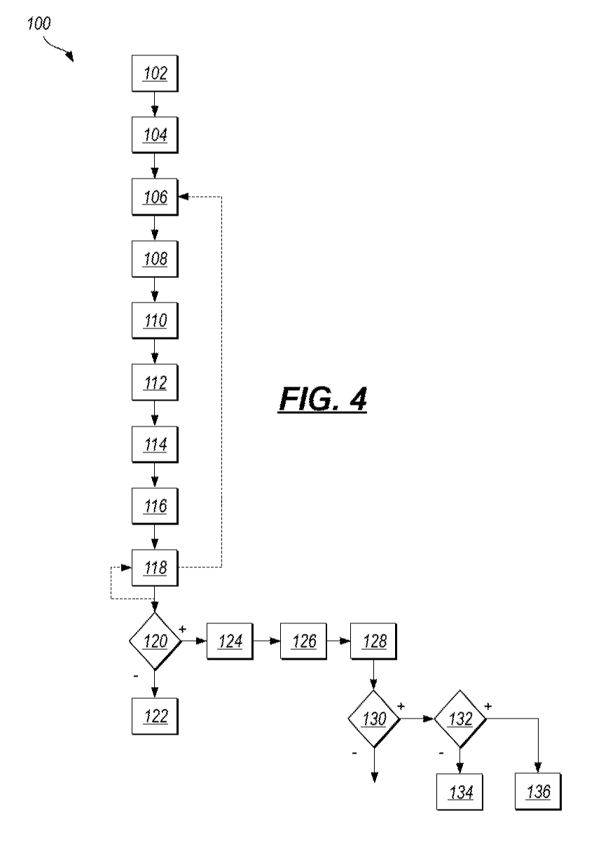

In one configuration, the accumulator 46 may be a sensor-less device, and thus P_{A} may be a calculated parameter. For example, the controller 30 may use its knowledge of the current accumulator volume 60, together with the known mechanics of the accumulator, to estimate P_{A}. The graph 90 in FIG. 3 represents one relational example of volume 92 and pressure 94 for a linear spring accumulator. Additionally, line pressure P_{L} may be calculated/modeled from prior knowledge of the physical layout of the system, together with the valve states, and the speed of the pump. As a further constraint, when the engine is off, and pump speed drops to zero (such as during an automatic stop/start event), line pressure may entirely vent to the sump 54 (e.g., via control valve 38).

FIG. 4 illustrates a method 100 of calculating an accumulator volume 60 to, for example, intervene to prevent an automatic engine stop (i.e., automatic stop/start). The method begins by monitoring the state of the plurality of control valves in the hydraulic control system (step 102), and monitoring the pump/engine speed (step 104).

In steps 106-112, the controller may ultimately determine a ΔP between the accumulator 46 and the fluid conduit, along with a temperature T of the fluid. The flow chart schematically illustrated in FIG. 4 is not intended to convey order to these steps, as many of the monitoring/calculating steps may occur concurrently. As such, the controller 30 may be configured to determine an accumulator pressure P_{A} (step 106) using a maintained estimate of accumulator volume together with the known mechanical dynamics of the accumulator. The estimate of accumulator volume may either be derived from known operating constraints of the physical system (as described above), or may be from previous calculations retained in memory that is associated with the controller 30 (i.e., AVₜ₋₁). As illustrated in FIG. 3, once the accumulator volume is estimated, the accumulator pressure P_{A} may be calculated using analytical formulae, graphs, or lookup tables that represent the mechanics of the accumulator.

In step 108, the controller 30 may determine a line pressure P_{L}, either through direct sensing, or by calculating the pressure from the known dynamics of the system, together with the state of the various control valves, accumulator status, and/or pump speed.

In step 110, the controller 30 may determine a temperature T of the hydraulic fluid, for example, by using a thermocouple or other temperature probe associated with the sump volume 54. Once P_{A}, P_{L}, and T are determined and/or calculated in steps 106-110, the controller 30 may compute ΔP by taking the difference between P_{A} and P_{L} (step 112).

For each of the scenarios 70, 72, 74 described above, the controller 30 may maintain a respective lookup table 170, 172, 174 that may represent ΔAV as a function of ΔP and T. In step 114, the controller 30 may select the scenario/lookup table that corresponds to the fill scenario/state of the hydraulic control system. The state may be generally determined using the operational status of the various control valves (monitored in step 102) together with the speed of the pump (monitored from step 104), and other computed parameters from steps 106-112. For example, the controller 30 may select the first lookup table 170 (corresponding to scenario 70) if the accumulator pressure (P_{A}) is greater than the line pressure (P_{L}), and the control valve 40 is on (open). The controller 30 may select the second lookup table 172 (corresponding to scenario 72) if the accumulator pressure (P_{A}) is less than the line pressure (P_{L}), and the control valve 40 is on (open). The controller 30 may select the third lookup table 174 (corresponding to scenario 74) if the accumulator pressure (P_{A}) is less than the line pressure (P_{L}), and the control valve 40 is off (closed). Finally, the controller 30 may select a fourth scenario as a default condition if no charge/discharge is occurring.

In step 116, the controller 30 may then select a ΔAV value from the lookup table/scenario chosen in step 114 using the ΔP value computed in step 112, and the temperature T monitored in step 110. The controller 30 may then integrate the ΔAV value with a previous, AVₜ₋₁ value to form a current, AVₜ value (step 118). As mentioned above, AVₜ may represent the current volume of fluid within the accumulator, whereas AVₜ₋₁ may represent a previous volume of fluid within the accumulator, and ΔAV may represent the estimated change in the volume of fluid within the accumulator between AVₜ₋₁ and AVₜ. The difference in time between the current and the previous volumes may be, for example, less than 500 ms.

The controller 30 may continuously compare the estimate of current accumulator volume AVₜ to a threshold in step 120. If AVₜ exceeds the threshold, then vehicle operation may be in a maximally responsive state (i.e., the accumulator is filled and capable of meeting any immediate pressure demands). Therefore, the system may rely on the accumulator to augment the fluid pump to engage the plurality of torque transmitting devices, for example in the re-start portion of an automatic stop/start.

If, however, AVₜ is less than the threshold in step 120, the controller 30 may indicate that the accumulator is unavailable to augment the pump, and certain vehicle functionality may be temporarily compromised. For example, as described above, when the vehicle is in a stationary condition, the controller 30 may want to perform an automatic stop to de-activate the engine. If, however, AVₜ is less than the threshold, the controller 30 may artificially interrupt the vehicle's ability to perform the automatic stop (step 122).

Said another way, when AVₜ is less than the threshold, the accumulator may not have enough stored fluid/pressure to fully apply a clutch to couple the input and output shafts of the transmission 14. Upon re-start, the low apply pressure may result in clutch slip, clutch judder, and/or rough acceleration. To avoid the occurrence of these conditions, the controller 30 may simply prevent the vehicle from automatically stopping until the accumulator volume 60 has increased to a sufficient level. Such a low-accumulator volume circumstance may occur if the driver attempts to perform multiple start/stops within a short period of time (e.g., in heavy stop/go traffic conditions).

If AVₜ exceeds the threshold in step 120, and if the controller 30 detects that the vehicle is stationary (step 124), the engine 12 may perform an automatic stop/start (step 126) as desired. Upon the re-starting of the engine 12, the controller 30 may monitor the various torque transmitting devices for any slip or judder (step 128), and compare the slip to a slip threshold (step 130). If the slip exceeds allowable limits, the controller may examine certain correction parameters to understand if numeric corrections are available (step 132). If so, the controller may modify a leakage correction factor (step 134), which may be a cumulatively maintained value. In this manner, a modeled leakage rate may increase from a previous amount. Such an increase in modeled leak rate may decrease AVₜ as a function of time whenever accumulator fill volume pressure is greater than the fluid conduit pressure. As such, the controller may respond by increasing the conduit pressure for the sole purpose of charging the accumulator fill volume pressure.

Independent of the leak rate correction factor, the controller may indicate in step 132 that past corrections were ineffective in reducing the slip by monitoring the number of adjacent restarts where clutch slip exceeds a predetermined threshold. In this instance, the controller 30 may provide an indicator alerting of a potential fluid leak within the hydraulic control system (at step 136). The indicator may be either a visual or auditory indicator to the driver of the vehicle, such as in the instrument cluster, or may be an indicator provided in a diagnostic log accessible by a service technician (e.g. an on-board diagnostic (OBD) log).

In another configuration, instead of basing the automatic stop/start determination on a volume estimate, the system may make such a determination using an estimated time-to-fill. The estimated time-to-fill may be based off of a ΔP, T, and starting accumulator pressure P₀, and may be adjusted using scaling factors/percentages such as those mentioned above. Once the accumulator has been in the predefined charging state for the determined time, it may be deemed to be sufficiently full to permit an automatic stop/start.

For example, FIG. 5 schematically illustrates one configuration of the time-based approach (generally at 200), which may occur following, for example, step 112 described above. As shown, in step 202, the controller 30 may select a time-to-fill value from a lookup table based off of an estimated ΔP, T, and starting accumulator pressure P₀ of zero. In step 204, the controller 30 may begin counting down a timer equal to the selected time-to-fill value. In step 206, the controller 30 may compare the running timer to a threshold, or determine if the timer has expired (in the case of a count-down timer). If the timer exceeds the threshold, or has expired, then the controller 30 may enable an automatic stop/start ability at step 208; otherwise, the controller 30 may prevent the vehicle from performing an automatic stop/start at step 210.

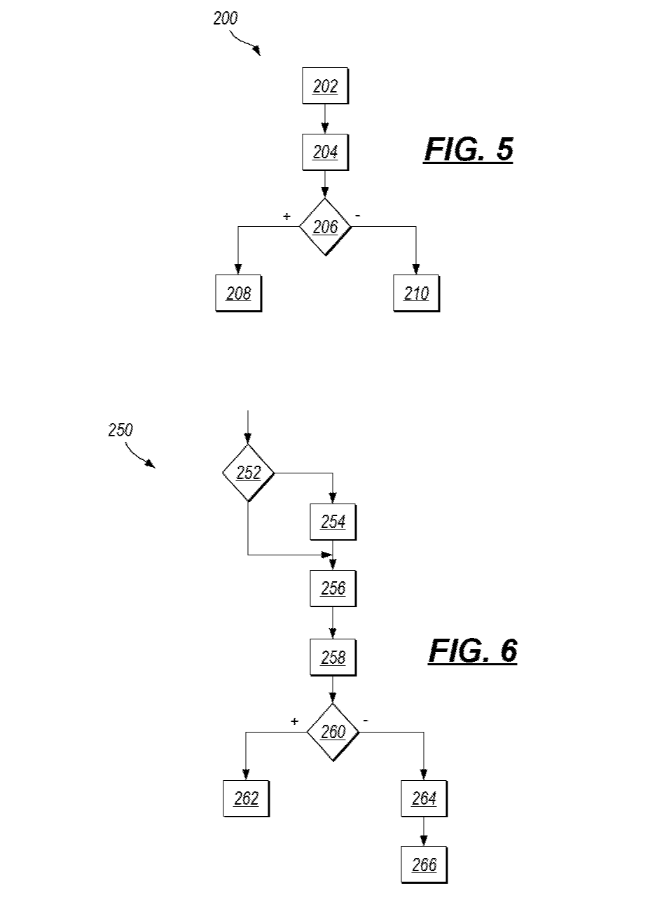

FIG. 6 schematically illustrates another embodiment of the time-based approach (generally at 250), which may occur following, for example, step 112 described above. In this embodiment, the controller 30 may account for an event that may deplete the pressure of the accumulator. As such, in step 252, the controller 30 may determine whether there has been an interruption in the accumulator fill, such as fluid being drawn off to engage a clutch. If an interruption is detected in step 252, the estimated accumulator pressure may be reset to zero in step 254, otherwise, the method may proceed without correction. In step 256, the controller 30 may select a time-to-fill value from a lookup table based off of an estimated ΔP, T, and starting accumulator pressure P₀.

In step 258, the controller 30 may begin counting down a timer equal to the selected time-to-fill value. In step 260, the controller 30 may compare the running timer to a threshold, or determine if the timer has expired (in the case of a count-down timer). If the timer exceeds the threshold, or has expired, then the controller 30 may enable an automatic stop/start ability at step 262; otherwise, the controller 30 may prevent the vehicle from performing an automatic stop/start at step 264. If an automatic stop/start is prevented, in step 266, the controller 30 may estimate an accumulator pressure using, for example, the time remaining on the timer, and an estimate for ΔP. This value may be the new initial pressure P₀ in a subsequent iteration of the method.

While the best modes for carrying out the invention have been described in detail, those familiar with the art to which this invention relates will recognize various alternative designs and embodiments for practicing the invention within the scope of the appended claims. It is intended that all matter contained in the above description or shown in the accompanying drawings shall be interpreted as illustrative only and not as limiting.

1. A method of preventing an automatic engine stop comprising:
determining a pressure difference between an accumulator fill volume and a fluid conduit in selective fluid communication with the accumulator fill volume;
determining a change in the accumulator fill volume from the determined pressure difference;
adding the change in the accumulator fill volume to a previous estimate of the accumulator fill volume to determine a current estimate of the accumulator fill volume;
comparing the current estimate of the accumulator fill volume to a predetermined threshold; and
preventing an automatic engine stop if the current estimate of the accumulator fill volume is below the predetermined threshold.

2. The method of claim 1, wherein determining a pressure difference between an accumulator fill volume and a fluid conduit in selective fluid communication with the accumulator fill volume includes:
estimating an accumulator pressure from both a previous estimate of the accumulator fill volume and an established relationship between volume and pressure for the accumulator;
determining a line pressure for the fluid conduit; and
calculating a difference between the estimated accumulator pressure and determined line pressure.

3. The method of claim 1 wherein determining a change in the accumulator fill volume from the determined pressure difference includes:
determining a fill status for the accumulator, the fill status corresponding to the rate and direction of fluid flow into or out of the accumulator;
selecting a lookup table corresponding to the determined fill status; and
selecting a change in the accumulator fill volume from the selected lookup table using the determined pressure difference.

4. The method of claim 3, further comprising:
monitoring a temperature of a hydraulic fluid, the hydraulic fluid configured to flow within the fluid conduit and accumulator fill volume; and
wherein the change in the accumulator fill volume is selected from the lookup table using the determined pressure difference and the monitored temperature.

5. The method of claim 1, further comprising:
permitting an automatic engine stop if the current estimate of the accumulator fill volume is above the predetermined threshold;
monitoring an amount of clutch slip during an automatic engine restart; and
applying a correction factor to an accumulator leakage rate if the amount of clutch slip exceeds a threshold.

6. The method of claim 5, wherein the correction factor is selected such that the estimate of accumulator fill volume decreases as a function of time if the pressure of the accumulator fill volume is greater than the pressure of the fluid conduit.

7. The method of claim 5, further comprising providing a fluid leak indicator if the correction factor exceeds a threshold.

8. A vehicle comprising:
an engine in power-flow communication with a transmission, the transmission including at least one fluidly actuated torque transmitting device;
a fluid pump in mechanical communication with the engine, and in selective fluid communication with the at least one fluidly actuated torque transmitting device through a fluid conduit, the fluid pump configured to supply a pressurized hydraulic fluid through the fluid conduit;
a hydraulic accumulator in fluid communication with the fluid conduit, the hydraulic accumulator defining an accumulator fill volume, and configured to maintain an amount of pressurized hydraulic fluid within the accumulator fill volume; and
a controller configured to estimate the amount of fluid within the accumulator fill volume by:
determining a pressure difference between the accumulator fill volume and the fluid conduit;
determining a change in the accumulator fill volume from the determined pressure difference; and
adding the change in the accumulator fill volume to a previous estimate of the accumulator fill volume to determine a current estimate of the accumulator fill volume.

9. The vehicle of claim 8, wherein the controller is further configured to:
compare the current estimate of the accumulator fill volume to a predetermined threshold; and
prevent the engine from automatically stopping if the current estimate of the accumulator fill volume is below the predetermined threshold.

10. The vehicle of claim 8, wherein the controller is configured to determine a pressure difference between the accumulator fill volume and the fluid conduit by:
estimating an accumulator pressure from both a previous estimate of the accumulator fill volume and an established relationship between volume and pressure for the accumulator;
determining a line pressure for the fluid conduit; and
calculating a difference between the estimated accumulator pressure and determined line pressure.

11. The vehicle of claim 8, wherein the controller is configured to determine a change in the accumulator fill volume from the determined pressure difference by:
determining a fill status for the accumulator, the fill status corresponding to the rate and direction of fluid flow into or out of the hydraulic accumulator;
selecting a lookup table corresponding to the determined fill status, the lookup table stored in memory associated with the controller; and
selecting a change in the accumulator fill volume from the selected lookup table using the determined pressure difference.

12. The vehicle of claim 11, wherein the controller is further configured to:
monitor a temperature of a hydraulic fluid; and
wherein the controller is configured to select the change in the accumulator fill volume from the lookup table using the determined pressure difference and the monitored temperature.

13. The vehicle of claim 8, wherein the controller is further configured to:
permit the engine to automatically stop if the current estimate of the accumulator fill volume is above the predetermined threshold;
monitor an amount of clutch slip during an automatic engine restart; and
apply a correction factor to an accumulator leakage rate if the amount of clutch slip exceeds a threshold.

14. The vehicle of claim 13, wherein the correction factor is selected such that the estimate of accumulator fill volume decreases as a function of time if the pressure of the accumulator fill volume is greater than the pressure of the fluid conduit.

15. The vehicle of claim 13, wherein the controller is further configured to provide a fluid leak indicator if the correction factor exceeds a threshold.

16. A method of preventing an automatic engine stop comprising:
determining a pressure difference between an accumulator fill volume and a fluid conduit in selective fluid communication with the accumulator fill volume;
determining an amount of time required to fill the accumulator fill volume from the determined pressure difference;
comparing an amount of time spent filling the accumulator to the determined amount of time required to fill the accumulator; and
preventing an automatic engine stop if the amount of time spent filling the accumulator is less than the determined amount of time required to fill the accumulator.

17. The method of claim 16, wherein determining a pressure difference between an accumulator fill volume and a fluid conduit in selective fluid communication with the accumulator fill volume includes:
estimating an accumulator pressure from both a previous estimate of the accumulator fill volume and an established relationship between volume and pressure for the accumulator;
determining a line pressure for the fluid conduit; and
calculating a difference between the estimated accumulator pressure and determined line pressure.

18. The method of claim 16, wherein determining an amount of time required to fill the accumulator fill volume from the determined pressure difference includes:
selecting a time value from a lookup table using the determined pressure difference.

19. The method of claim 18, further comprising:
monitoring a temperature of a hydraulic fluid, the hydraulic fluid configured to flow within the fluid conduit and accumulator fill volume; and
wherein the time value is selected from the lookup table using the determined pressure difference and the monitored temperature.

20. The method of claim 18, further comprising:
permitting an automatic engine stop if the amount of time spent filling the accumulator is greater than the determined amount of time required to fill the accumulator;
monitoring an amount of clutch slip during an automatic engine restart; and
applying a correction factor to an accumulator leakage rate if the amount of clutch slip exceeds a threshold.
